(19) United States
(12) Patent Application Publication
(10) Pub. No.: US 2010/0295376 A1
(43) Pub. Date: Nov. 25, 2010

(54) SYSTEMS AND METHODS FOR DYNAMIC POWER ALLOCATION

(75) Inventors: Eric K. Black, Seattle, WA (US); Michael J. Black, Seattle, WA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: TRUE SOL INNOVATIONS, INC., Seattle, WA (US)

(21) Appl. No.: 12/535,829

(22) Filed: Aug. 5, 2009

Related U.S. Application Data
(60) Provisional application No. 61/180,754, filed on May 22, 2009.

(51) Int. Cl. H02J 1/00

(52) U.S. Cl. 307/80

(57) ABSTRACT

Disclosed herein are systems and methods for providing power to a load. Systems according to the present embodiment may include an electrical generator to generate electrical power and a battery to store electrical power. The present disclosure may be applied to electrical power generators having variable outputs, and may be utilized to provide a more constant electrical output by drawing power from the electrical generator and the battery as necessary to satisfy the power requirements of the electrical load. The system draws power from the electrical power generator and the battery to satisfy the power requirements of the load. Based on a mode of operation, the system may draw power only from the battery, only from the electrical power generator, or from both the electrical power generator and the battery alternately.

### TECHNICAL FIELD

The present disclosure relates to systems and methods for providing power to an electronic device. More specifically, the present disclosure relates to a system configured to dynamically draw power from a variable power source and a battery to satisfy the power requirement of a load.

### BRIEF DESCRIPTION OF THE DRAWINGS

FIG. 1 illustrates an embodiment of a system according to the present disclosure incorporated into a shoulder bag.

FIG. 2 illustrates an embodiment of a system according to the present disclosure incorporated into a tent.

FIG. 3 is a block diagram of a system for dynamic power allocation, according to one embodiment.

FIG. 4 is a flow chart illustrating various states of operation of a system for dynamic power allocation shown in FIG. 3, according to one embodiment.

FIG. 5 is a flow chart illustrating one embodiment for allocating power between two outputs in the system for dynamic power allocation shown in FIG. 3.

FIGS. 6A, 6B, 6C, 6D, and 6E are schematics illustrating in greater detail one embodiment of the system illustrated in FIG. 3.

### DETAILED DESCRIPTION OF PREFERRED EMBODIMENTS

Disclosed herein are systems and methods for providing power to an electrical load. The systems and methods disclosed herein may be incorporated into a variety of products, including but not limited to backpacks, backpack covers, briefcases, luggage, duffel bags, coolers, outdoor gear, clothing, tents, awnings and the like. Systems according to the present embodiment include an electrical power generator and a battery to store electrical power. The system draws power from the electrical power generator and the battery to satisfy the power requirements of the load. A variety of electrical power generators may be utilized, including a solar panel, a motion energy generator, a wind turbine, a wave power generator, a rotary generator, and the like. The present disclosure may be applied to electrical power generators having variable outputs, and may be utilized to provide a more constant electrical output by drawing power from the electrical power generator and the battery as necessary to satisfy the power requirements of the load.

The teachings of the present disclosure may be applied on a broad range of sizes and power requirements. In certain embodiments, a system according to the present disclosure may be configured to provide power to portable electronics, including but not limited to portable computers, music players, video players, television equipment, mobile telephones, cameras, navigation equipment, medical equipment, clocks, and the like.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture, a method, and a product of a process.

The phrases “connected to,” and “in communication with” refer to any form of interaction between two or more entities, including mechanical, electrical, magnetic, and electromagnetic interaction. Two components may be connected to each other even though they are not in direct contact with each other and even though there may be intermediary devices between the two components.

The described features, operations, or characteristics may be combined in any suitable manner in one or more embodiments. It will also be readily understood that the order of the steps or actions of the methods described in connection with the embodiments disclosed herein may be changed as would be apparent to those skilled in the art. Thus, any order in the drawings or detailed description is for illustrative purposes only and is not meant to imply a required order, unless specified to require an order.

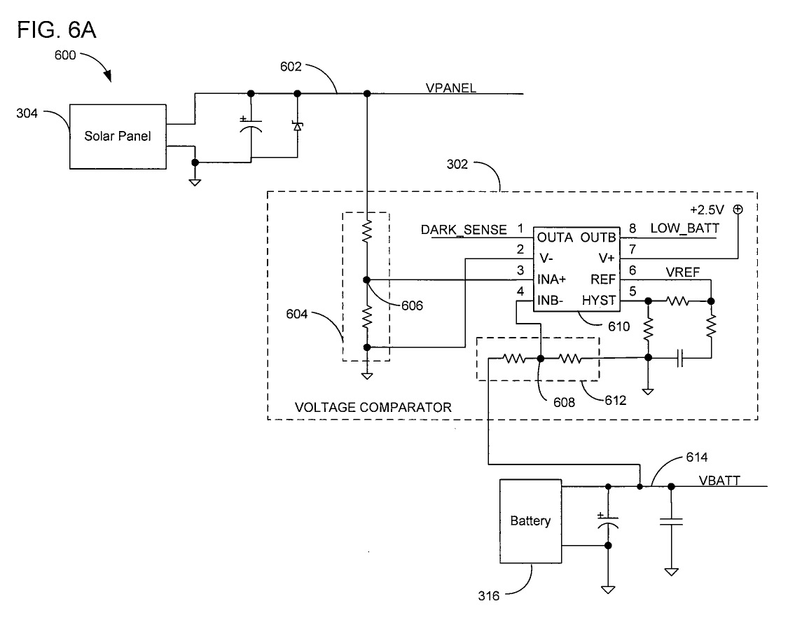

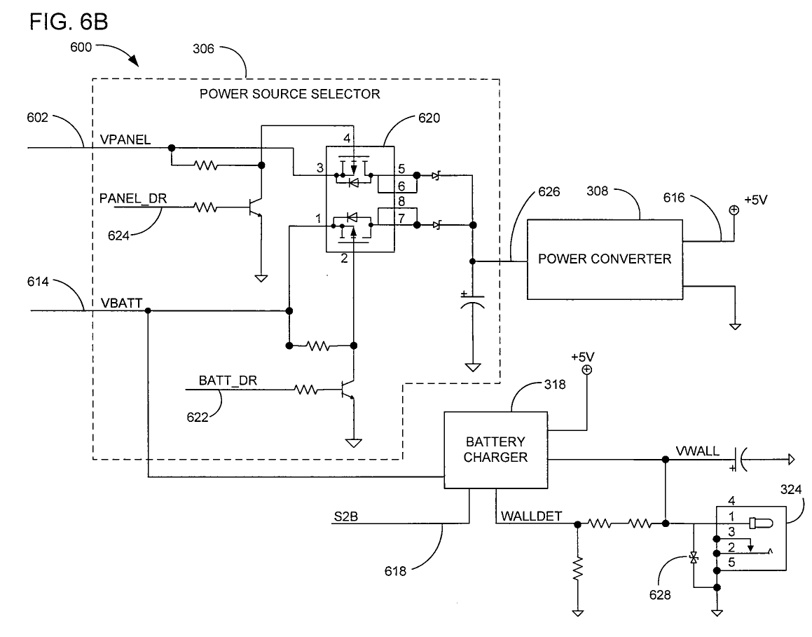

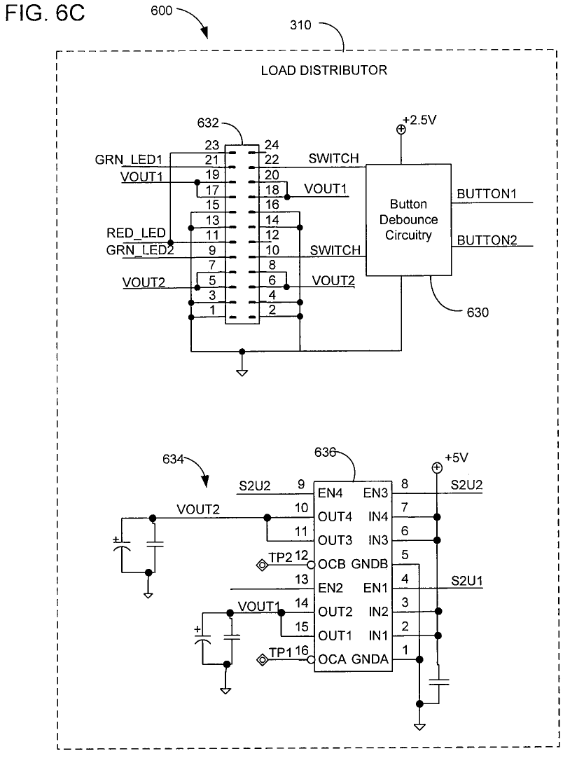

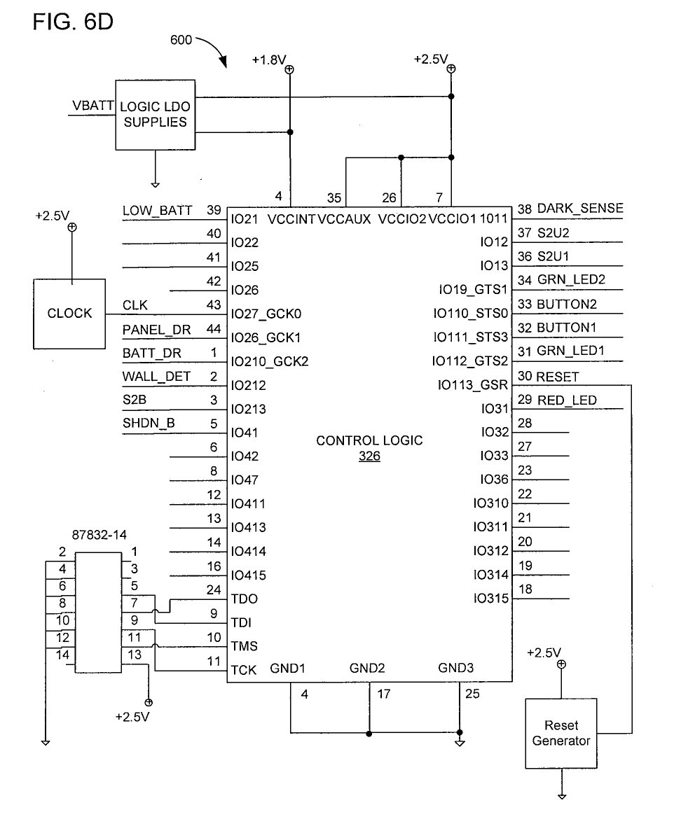

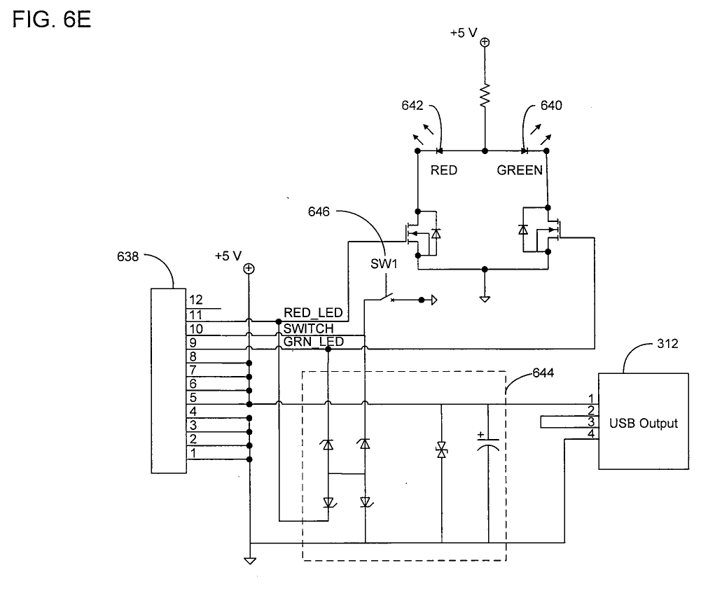

Reference numbers indicated in the drawings are each greater than 100. Numbers in the drawings less than 100 in FIGS. 6A-6E are pin numbers of various commercially available integrated circuits used in exemplary embodiments.

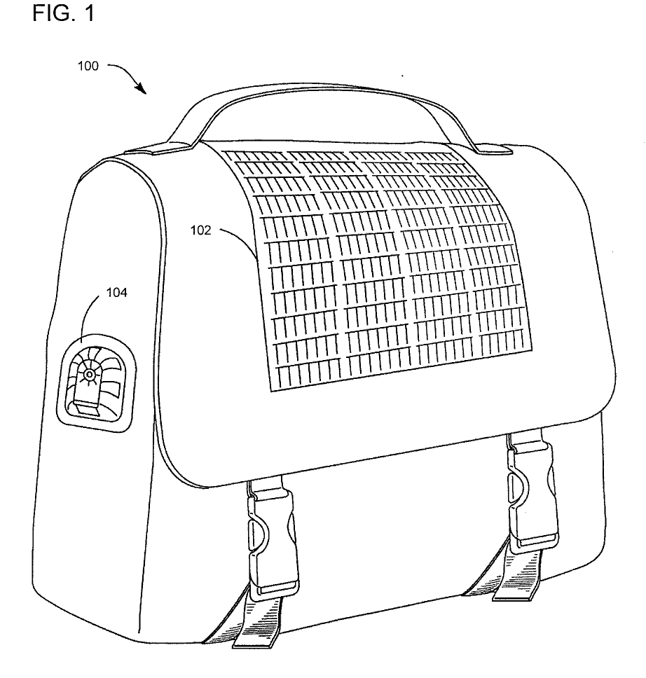

FIG. 1 illustrates an embodiment of a system according to the present disclosure incorporated into a shoulder bag 100. Solar panel 102 is disposed on the exterior of shoulder bag 100, and generates electrical power when exposed to light. The electrical power generated by solar panel 102 may be used to power an output 104, or may be used to charge a battery (not shown) disposed inside shoulder bag 100. Multiple bags may be connected together to generate greater power to one or all of the bags. Multiple bags may be connected by connecting the electrical output from the solar panel of one or more bags to a single bag. Connecting the output of multiple solar panels to a single bag system allows for greater power production.

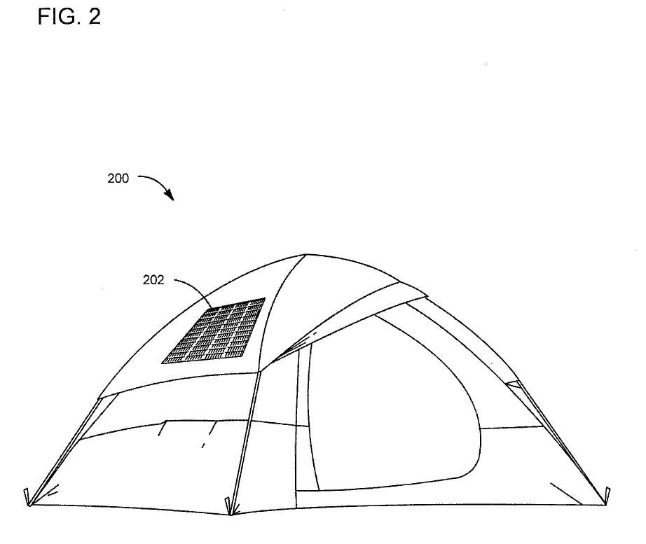

FIG. 2 illustrates an embodiment of a system according to the present disclosure incorporated into a tent 200. Electrical energy generated by solar panel 202 may be used to power portable electronics, as described above, as well as lighting within the tent.

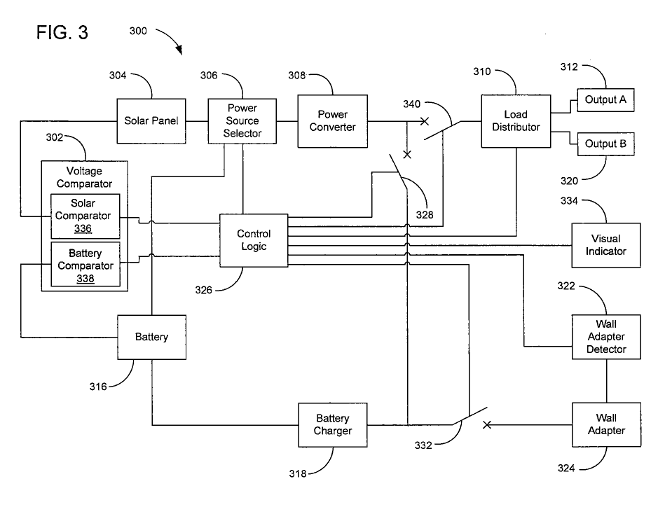

FIG. 3 illustrates a block diagram of one embodiment of a system 300 for dynamic power allocation according to the present disclosure. System 300 provides electrical power to output A 312 and output B 320. Output A 312 and output B 320 may be connected to a variety of electrical devices. Output A 312 and output B 320 may be embodied as a variety of electrical connections, including Universal Serial Bus (USB), IEEE 1394, an automobile lighter socket (i.e. a 12 volt connection), and the like. System 300 may receive electrical power from two sources, namely solar panel 304 and wall adapter 324. In alternate embodiments, solar panel 304 may be replaced by another form of electrical generator. Either source of electrical power 304 or 324 may be used to charge a battery 316. Battery 316 stores electrical power, and may be embodied as any form of electrical or electrochemical energy storage system, such as an alkaline battery, a carbon-zinc battery, a nickel-cadmium battery, a lithium battery, a lead-acid battery, and the like. The capacity of battery 316 may be selected based on the application. Solar panel 304 may be embodied as any type of photovoltaic module, including rigid or flexible modules. In certain embodiments, solar panel 304 may have an output between 2 and 50 watts.

When system 300 is connected to a power source by wall adapter 324, system 300 may charge battery 316 and may provide power at output A 312 and/or output B 320. Wall adapter 324 may convert electrical power received from a wall socket (not shown) into a suitable voltage for charging battery 316 and powering output A 312 and output B 320. In one embodiment, wall adapter 324 receives AC power at 120 V, 60 hertz, and converts the AC power to DC power at 5 V. Wall adapter detector 322 detects electrical power from wall adapter 324. Wall adapter detector 322 may send a signal to control logic 326 to indicate when power is available from wall adapter 324. In response, control logic 326 may close switch 332 and open switch 328. Closing switch 332 provides electrical power to battery charger 318, which in turn charges battery 316. When a wall adapter is connected, system 300 is in a wall adapter charging mode. In some embodiments, wall adapter 324 provides power to output A 312 or output B 320 indirectly through battery 316 being connected to the input of power converter 308. In other embodiments, wall adapter 324 provides power to battery charger 318 and output A 312 and/or output B 320.

Power generated by solar panel 304 may be used to charge battery 316 when a load is not connected to system 300. In such circumstances, control logic 326 may close switch 328, open switch 340, and configure system 300 in a solar panel charging mode, wherein solar panel 304 is connected to power converter 308. Power from solar panel 304 is thus routed from solar panel 304 to charge battery 316.

A voltage comparator 302 may be connected to solar panel 304 and battery 316. Voltage comparator 302 may comprise a solar comparator 336 and a battery comparator 338, which are respectively operable to compare the outputs of solar panel 304 and battery 316 to pre-determined threshold voltages in order to determine the operating conditions of solar panel 304 and battery 316. Voltage comparator 302 may generate control signals that are used by control logic 326. In one embodiment, battery comparator 338 generates a signal corresponding to a low battery state (e.g. battery 316 is less than 10% charged). Solar comparator 336, may generate a control signal that corresponds to the approximate power output of solar panel 304.

When a load is connected to either output A 312 or output B 320, power source selector 306 is configured to be in a hybrid mode. In hybrid mode, power is drawn dynamically from solar panel 304 and/or battery 316 in order to satisfy the electrical requirements of the load. In hybrid mode, control signals received from control logic 326 control the amount of power transmitted from solar panel 304 and battery 316 to power converter 308 in such a manner that solar panel 304 provides the maximum amount of power that it is capable of delivering based upon the environmental conditions at the moment and the total amount of power that the user is consuming. When in hybrid mode, battery 316 periodically provides power to output A 312 or output B 320, such that power converter 308 maintains a regulated output voltage at the maximum available load current. In hybrid mode, power source selector 306 automatically switches the input of power converter 308 between solar panel 304 and battery 316. The frequency of the switching depends on ambient environmental conditions. The minimum period of this switching may be in a range of 1 microsecond to 500 milliseconds. The maximum period of this asynchronous switching may be unbounded. In one embodiment, the range of the lower bound is determined by the time necessary for voltage comparator 302 to respond, in addition to the time necessary for power source selector 306 to actuate. In certain embodiments, power source selector 306 is embodied as a 2-to-1 analog multiplexor. In other embodiments, additional types of power generators may be accommodated by including additional inputs in a multiplexor. For example, one embodiment may include both a solar panel 304 and a motion energy generator (not shown). The output of the solar panel 304, the output of the motion energy generator, and a battery may be connected to a 3-to-1 analog multiplexor. In such an embodiment, system 300 may generate power both from motion and from light.

Power converter 308 receives power from power source selector 306 and provides a regulated output at a specific voltage using input power from power source selector 306. Power converter 308 may be operable to convert one DC input voltage into one or more output DC voltages. In certain embodiments, power converter 308 may be embodied as a single ended primary inductor converter (SEPIC), which is operable to output a voltage that is greater than, less than, or equal to the input voltage.

Load distributor 310 may be operable to selectively provide power to either output A 312, output B 320, or both output A 312 and output B 320. Load distributor 310 may also be operable to detect when a load is disconnected from output A 312 or output B 320. A load disconnection event may be detected in a variety of ways. In one embodiment, sensors may be placed on electrical output A 312 and output B 320 to detect the disconnection event. In an alternate embodiment, a sensor may be placed between power converter 308 and load distributor 310 to achieve the same functionality. Additionally, load distributor 310, in conjunction with control logic 326, may be operable to detect the presence of a user device connected to either output A 312 or output B 320. In one embodiment, load distributor 310 provides power to the connected output until a disconnection event is sensed. In still other embodiments, a button may be pressed to enable output A 312 or output B 320. When a load disconnection event is detected, the appropriate electrical output A 312 or output B 320 may be de-activated and system 300 may enter solar panel charging mode. In some embodiments having more than one electrical output, only one electrical output is active at any one time. For example, output A 312 may be electrically inactive while output B 320 is electrically active, and output A 312 may be electrically active while output B 320 is electrically inactive. System 300 may provide power to the load connected most recently (e.g. if output A 312 is electrically active and a load is later connected to output B 320, output B 320 becomes electrically active and output A 312 becomes electrically inactive). In other embodiments, output A 312 and output B 320 may be active at the same time. In still other embodiments, output B 320 may not become active until output A 312 is disconnected and vise versa.

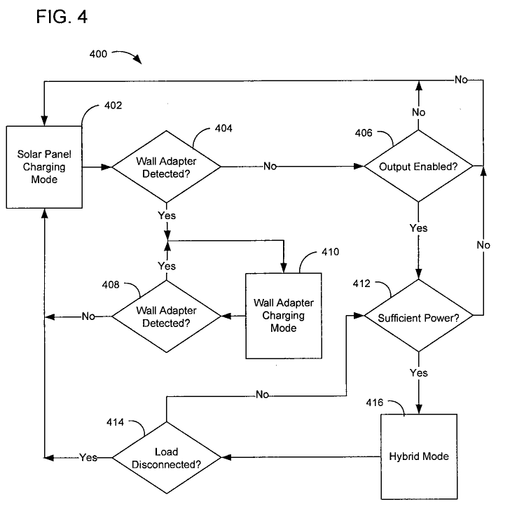

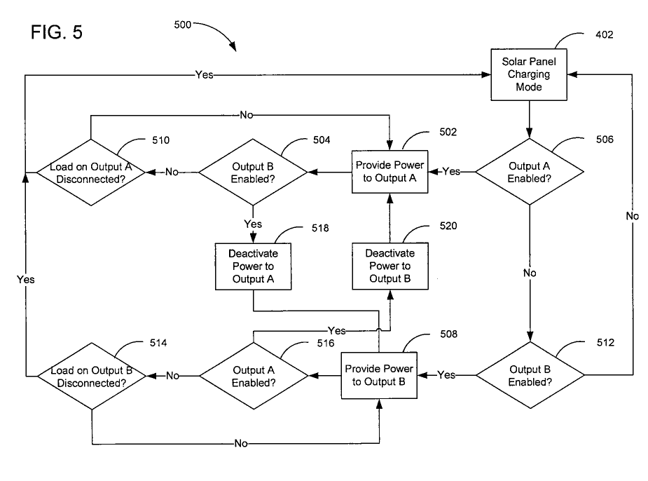

Control logic 326 processes various inputs and generates various outputs in order to control the operation of system 300. Control logic 326 may be implemented in a variety of forms, including as an embedded processor, an Application Specific Integrated Circuit (ASIC), a Field Programmable Gate Array (FPGA), or the like. Control logic 326 is operable to control operation according to the various modes described below in connection with FIGS. 4 and 5.

FIG. 4 is a flow chart illustrating various states of operation of a system 400. In the embodiment illustrated in FIG. 4, the default state of a system 400 is solar panel charging mode 402. The system may transition to wall adapter charging mode 410 if power from a wall adapter is detected 404. In wall adapter charging mode 410, system 400 determines whether the wall adapter is detected 408. When the wall adapter is no longer detected, system 400 transitions from wall adapter charging mode 410 to solar panel charging mode 402. In wall adapter charging mode 410, power may be provided to one or more outputs while the battery is being charged.

If no wall adapter is detected at step 404, system 400 determines whether an output is enabled 406. If no output is enabled, system 400 returns to solar panel charging mode 402. If an output is enabled, system 400 determines at step 412 whether sufficient power is available 412 to power the load connected to the output. As described above, power may be provided by the battery, solar panel, or the combination of the solar panel and the battery. If sufficient power is not available, system 400 transitions to solar panel charging mode 402. A visual indicator may be given to a user to indicate that system 400 is unable to power the load. In one embodiment, the visual indicator comprises flashing a red LED.

If sufficient power is available at step 412, system 400 enters hybrid mode 416. In hybrid mode 416, system 400 determines whether the load has been disconnected 414. If the load has been disconnected, system 400 transitions to solar panel charging mode 402. If the load has not been disconnected, system 400 determines whether sufficient power remains 412 to continue powering the load. If sufficient power is not available, system 400 transitions to solar panel charging mode 402. If sufficient power is available, system 400 remains in hybrid mode 416.

FIG. 5 is a flow chart illustrating one embodiment for allocating power between two outputs in a system 500. In the embodiment illustrated in FIG. 5, system 500 provides power to the load connected most recently, or provides power to charge a battery if no load is connected. The default state of FIG. 5 is solar panel charging mode 402. In solar panel charging mode 402, power generated by a solar panel is routed to a battery. In solar panel charging mode 402, system 500 determines whether output A is enabled 506. If output A is enabled, system 500 provides power to output A 502. System 500 then determines whether output B is enabled 504. If output B is enabled, system 500 deactivates power to output A 518 and begins to provide power to output B 508. If output B is not enabled, system 500 determines whether a load on output A has been disconnected 510. If the load on output A has been disconnected, system 500 returns to solar panel charging mode 402. If the load on output A has not been disconnected, system 500 continues to provide power to output A 502.

If at step 506 output A is not enabled, system 500 determines whether output B is enabled 512. If neither output A nor output B are enabled, system 500 returns to solar panel charging mode 402. If output B is enabled, system 500 provides power to output B 508. System 500 then determines whether output A is enabled 516. If output A is enabled, system 500 deactivates power to output B 520 and provides power to output A 502. If output A is not enabled, system 500 determines whether the load on output B has been disconnected 514. If the load on output B has been disconnected, system 500 returns to solar panel charging mode 402. If the load on output B has not been disconnected, system 500 continues to provide power to output B 508. A similar system for allocating power between two outputs may also be utilized in connection with hybrid mode (ref. no.416 in FIG. 4).

FIGS. 6A, 6B, 6C, and 6D are schematics illustrating in greater detail one implementation of system 300, shown in FIG. 3. FIG. 6A illustrates various electrical connections between solar panel 304, voltage comparator 302, and battery 316. The line 602 carrying electrical energy generated by solar panel 304 is labeled VPANEL. The line 614 carrying electrical energy to or from battery 316 is labeled VBATT. Line VBATT 614 is connected to a voltage divider 612 and the divided voltage at node 608 is in communication with a comparator circuit 610. The divided voltage at node 608 provides an indication of the operating conditions of battery 316. As power output from battery 316 decreases, the voltage at node 608 also decreases, and thus may be used to signal when battery 316 has insufficient power to power a load. In the illustrated embodiment, comparator circuit 610 is embodied as part number LTC1442 available from Linear Technology Corporation, Milpitas, Calif. (“Linear”). Line VPANEL 602 is connected to voltage divider 604, and the divided voltage at node 606 is in communication with comparator circuit 610. The divided voltage at node 606 provides an indication of the operating conditions of solar panel 304. As power output from solar panel 304 decreases, the voltage at node 606 also decreases, and thus may be used to signal when power should be drawn from battery 316 to power the load. The comparator circuit 610 generates an output signaling a low battery state, LOW_BATT, as well as an output signaling an indication of the power generated by solar panel 304, DARK_SENSE. The outputs generated by comparator circuit 610 are inputs to control logic 326 (shown in FIG. 6D).

FIG. 6B illustrates various connections between power source selector 306, power converter 308, battery charger 318, and wall adapter 324. Power source selector 306 is embodied as a 2-to-1 analog multiplexor. Lines VPANEL 602 and VBATT 614 provide power to power source selector 306. A multiplexor output 626 provides power to power converter 308. Lines PANEL_DR 624 and BATT_DR 622 are generated by control logic 326 (shown in FIG. 6D) and determine whether solar panel 304 or battery 316 is connected to the input of power converter 308 at multiplexor output 626. In one embodiment, in solar panel charging mode (ref. no. 402 in FIG. 4), PANEL_DR 624 is set to a static logical 1 and BATT_DR 622 is set to a static logical 0. With PANEL_DR 624 set to static logical 1 and BATT_DR 622 set to static logical 0, VBATT 614 is precluded from providing energy to power converter 308 and VPANEL 602 is locked in connection with power converter 308. In wall adapter charging mode (ref. no. 410 in FIG. 4), PANEL_DR 624 is set to a static logical 0 and BATT_DR 622 is set to a static logical 1. With PANEL_DR 624 set to static logical 0 and BATT_DR 622 set to static logical 1, VPANEL 602 is precluded from providing energy to power converter 308 and VBATT 614 is locked in connection with power converter 308. In hybrid mode (ref. no. 416 in FIG. 4), control logic 326 directly connects the DARK_SENSE signal coming from comparator circuit 610 to PANEL_DR 624. Also during hybrid mode 416, BATT_DR 622 is connected to the complement of the DARK_SENSE signal coming from comparator circuit 610. When the power provided by solar panel 304 is insufficient to meet the requirements of a connected load, the DARK_SENSE signal toggles between high and low at a frequency that allows solar panel 304 to provide maximum available power. An electrostatic discharge (ESD) protection circuit 528 may be included. ESD protection circuit 528 is embodied as part no. SMA6J6.0CA, available from STMicroelectronics, Geneva, Switzerland. Battery charger 318 may be embodied as a combination of part nos. LTC4061 and LTC4413, available from Linear. Power converter 308 may comprise part no. LT1618, available from Linear.

FIG. 6C illustrates various circuitry in load distributor 310 including a PCB transition connector 632, embodied as model no. AWLP-24/3.2-G-R, available from Assmann Electronics, Inc., Tempe, Ariz. A cable (not shown) may connect PCB transition connector 632 to two instances of connector 638 (shown in FIG. 6E). In other words, a first instance may connect to pins 1-12 of connector 632 and a second instance may connect to pins 13-24 of connector 632. In this way output A 312 and output B 320 (shown in FIG. 3) are embodied as two unique instances of the circuitry illustrated in FIG. 6E. Load distributor 310 also includes power distribution switch 636, embodied as model no. TPS2085D, available from Texas Instruments Incorporated, Dallas, Tex. In certain embodiments, power distribution switch 636 embodies switch 340 in FIG. 3.

FIG. 6D illustrates various signals coming into and out of control logic 326, embodied as model no. XC2C64A available, from Xilinx, Inc., San Jose, Calif.

FIG. 6E illustrates various circuitry associated with an output port 312. In the illustrated embodiment, output port 312 is a USB port. Connector 638 connects to PCB transition connector 632 (shown in FIG. 6C). An ESD protection circuit 644 is included. A red LED 642 and a green LED 640 may be selectively activated to provide a visual indicator to a user regarding the availability of power. The red LED 642 may signal that battery 316 contains insufficient power to satisfy the requirement of the load. The green LED 640 may signal that power is being delivered to output port 312. SW1 646 is used in one embodiment in connection with determining whether output A or output B is enabled (ref. nos. 506 and 512 in FIG. 5). In the illustrated embodiment, SW1 is an electrical reference designator for a mechanical switch.

Those having skill in the art will recognize that many changes may be made to the details of the above-described embodiments without departing from the underlying principles of the invention.

1. A system to provide power to a first load having a power requirement, the system comprising:
an electrical power generator configured to generate electrical power;
a battery configured to store electrical power;
a power source selector in electrical communication with the electrical power generator and in electrical communication with the battery, the power source selector configured to dynamically draw power from the electrical power generator and the battery to satisfy the power requirement of the first load; and
a first electrical output, the first electrical output in electrical communication with the power source selector and connectable to the first load.

2. The system of claim 1, wherein the power source selector is configured to draw power only from the electrical power generator when the electrical power generator generates sufficient electrical power to satisfy the power requirement of the first load.

3. The system of claim 1, wherein the power source selector is configured to alternately draw power from the electrical power generator and the battery when the electrical power generator generates insufficient electrical power to satisfy the power requirement of the first load.

4. The system of claim 1, wherein the power source selector is configured to switch between power drawn from the electrical power generator and power drawn from the battery at a minimum switching period in the range between 1 microsecond and 500 milliseconds when the electrical power generator generates insufficient electrical power to satisfy the power requirement of the first load.

5. The system of claim 1, wherein the power source selector is configured to draw power only from the battery when the electrical power generator generates no electrical power.

6. The system of claim 1, wherein the electrical power generator comprises a solar panel.

7. The system of claim 6, further comprising a voltage detector connected to an output of the solar panel, and wherein the voltage detector causes the power source selector to draw power from the battery when the voltage at the output of the solar panel is less than a threshold amount.

8. The system of claim 1, further comprising:
an analog multiplexor, the analog multiplexor comprising,
a first power input in electrical communication with the electrical power generator,
a second power input in electrical communication with the battery,
a power output in electrical communication with the first electrical output,
a first control input operable to control the flow of power transmitted between the first power input and the power output, and
a second control input operable to control the flow of power transmitted between the second power input and the power output.

9. The system of claim 8, further comprising a control unit configured to dynamically adjust the first control input and the second control input based on the power requirement of the first load and the electrical power generated by the electrical generator.

10. The system of claim 1, wherein the first electrical output comprises a universal serial bus (USB) port.

11. The system of claim 1, further comprising a second electrical output in electrical communication with the solar panel and in electrical communication with the battery, the second electrical output configured to be connected to a second load, and to provide power to the second load.

12. The system of claim 11, wherein the second electrical output is inactive while the first electrical output is active, and wherein the first electrical output is active while the second electrical output is inactive.

13. The system of claim 1, further comprising a sensor to determine when the first load is connected to the first electrical output.

14. The system of claim 1, further comprising a DC/DC power converter coupled between the power source selector and the first electrical output port.

15. The system of claim 14, wherein the power converter comprises a SEPIC power converter.

16. The system of claim 1, further comprising:
a battery charger in electrical communication with the power converter.

17. The system of claim 1 further comprising a plurality of electrical power generators configured to generate electrical power, and wherein the plurality of electrical power generators are in electrical communication with the power source selector.

18. A method for providing power to a first load having a power requirement, the method comprising:
generating electrical power using an electrical power generator;
storing electrical power using a battery;
connecting the first load to a first electrical output;
connecting the first electrical output to a power source selector in electrical communication with the electrical power generator and in electrical communication with the battery, the power source selector drawing power dynamically from the solar panel and the battery to satisfy the power requirement of the first load.

19. The method of claim 18, further comprising drawing power only from the electrical power generator when the electrical power generator generates sufficient electrical power to satisfy the power requirement of the first load.

20. The method of claim 18, further comprising drawing power alternately from the electrical power generator and the battery when the electrical power generator generates insufficient electrical power to satisfy the power requirement of the first load.

21. The method of claim 18, further comprising switching between drawing power from the electrical power generator and the battery at a minimum switching period in the range between 1 microsecond and 500 milliseconds when the electrical power generator generates insufficient electrical power to satisfy the power requirement of the first load

22. The method of claim 18, further comprising drawing power only from the battery when the electrical power generator generates no electrical power.

23. The method of claim 18, wherein the electrical power generator comprises a solar panel.

24. The method of claim 18, further comprising:
detecting a voltage at an output of the solar panel, and
drawing power from the battery when the voltage at the output of the solar panel is less than a threshold amount.

25. The method of claim 18, further comprising:
multiplexing the electrical power generated by the electrical power generator with the electrical power stored in the battery using,
a first control input operable to control the flow of power transmitted between the first power input and the power output, and
a second control input operable to control the flow of power transmitted between the second power input and the power output.

26. The method of claim 25, further comprising:
adjusting the first control input and the second control input based on the power requirement of the first load and the electrical power generated by the electrical power generator.

27. The method of claim 18, wherein the first electrical output comprises a universal serial bus (USB) port.

28. The method of claim 18, further comprising connecting a second load to a second electrical output in electrical communication with the electrical power generator and in electrical communication with the battery.

29. The method of claim 28, further comprising:
deactivating the second electrical output when the first load is connected to the first electrical output; and
deactivating the first electrical output when the second load is connected to the second electrical output.

30. The method of claim 18, further comprising detecting when the load is connected to the first electrical output.

31. The method of claim 18, further comprising converting the electrical power generated by the electrical power generator from a first DC voltage to a second DC voltage using a power converter.

32. The method of claim 18, wherein the power converter comprises a SEPIC power converter.

33. The method of claim 18, further comprising:
charging the battery using electrical power generated by the electrical power generator.

34. A system to provide power to a load having a power requirement, the system comprising:
a power generating means;
a power storage means;
a power source selector means for dynamically drawing power from the power generating means and the battery to satisfy the power requirement of the load, the power source selector means in electrical communication with the power generating means and the power storage means; and
a power output means for providing power to the load, the power output means in electrical communication with the power source selector means.

35. The system of claim 34, wherein the power source selector means is configured to alternately draw power from the power generating means and the power storage means when the power generating means generates insufficient electrical power to satisfy the power requirement of the load.

36. A system to provide power to a first load having a power requirement, the system comprising:
a solar panel configured to generate electrical power;
a battery configured to store electrical power;
an analog multiplexor comprising,
a first power input in electrical communication with the solar panel,
a second power input in electrical communication with the battery,
a power output,
a first control input operable to control the flow of power transmitted between the first power input and the power output, and
a second control input operable to control the flow of power transmitted between the second power input and the power output;
a first electrical output, the first electrical output in electrical communication with the power output of the analog multiplexor and connectable to the first load; and
a control unit configured to dynamically adjust the first control input and the second control input to draw power from the solar panel and the battery to satisfy the power requirement of the first load.
